(19) United States
(12) Patent Application Publication
(10) Pub. No.: US 2004/0201610 A1
(43) Pub. Date: Oct. 14, 2004

(54) Video player and authoring tool for presentions with tangential content

(76) Inventors: Robert E. Rosen, Agoura Hills, CA (US); David B. Rosen, Tarzana, CA (US)

Correspondence Address: Oppenheimer Wolff & Donnelly LLP, Suite 3300, 45 South Seventh Street, Minneapolis, MN, 55402-1609, US

(21) Appl. No.: 10/010,803

(22) Filed: Nov. 13, 2001

(51) Int. Cl. G06F 17/21; G09G 5/00; G06F 17/24

(52) U.S. Cl. 345/731; 345/730; 715/500.1

(57) ABSTRACT

A multimedia player parses a presentation script for delivering to a user a presentation that is comprised of a video, slides and tangential content. Each slide is associated to part of the tangential content and to a specific playback time or frame within the video. The presentation script describes the relationships among the video, the tangential content and the slides. The multimedia player has a presentation control unit which provides the graphical user interface for displaying the video and the slides, and for allowing the user to manipulate the presentation. The player allows the user to select one of the slides to access the tangential content which has been associated to the slide according to the presentation script. In another embodiment, a presentation authoring tool allows a user to generate a presentation script describing the relationships among a video, a set of slides, and a set of tangential content.

### BACKGROUND OF THE INVENTION

This invention relates generally to multimedia presentations. Particularly, this invention relates to a method of generating and playing a multimedia content presentation in which a video is shown and tangential content is presented at preset points in the video.

In the prior art, video players have allowed computer users to play standalone video files or streaming files from the Internet. For example, the Microsoft brand Windows operating system comes installed with the “Windows Media Player” application. As another example, Real.com provides computer users with their “RealPlayer,” another popular video viewing application. These players are similar to the common VCR in that the user accesses controls to move forward and backwards through the video, pausing at any point.

In recent times, the corporate world has discovered the advantages of using webcasting and videos for training and consumer information purposes. In August 2001, the Wall Street Journal ran a story by Riva Richmond about the emerging industry of webcasting. According to experts at research firm Jupiter Media Metrix Inc., spending on webcasts for product launches may reach $567 million by 2005. Similar technology for employee training may become a $519 million market by 2005.

The use of webcasting and streaming videos, and the like, as part of e-learning tools are cost effective. For example, one luxury car maker has created an e-learning training program for its new mechanics. The new program eliminates costs for travel to corporate training centers and decreases the mechanics' time away from work. From these cost saving advantages, the e-learning video program recovered its production costs after just 50 students completed the course. A primary reason for the growth of such video technology is the cost savings for corporate America.

Unfortunately, current systems that allow users to play videos (either of the streaming or traditional variety) or to replay recorded webcasts from a computer have disadvantages. First, it is difficult for the user to easily find and review portions of the videos. As with traditional taping through a VCR, a user must fiddle around with the “rewind” and “fast forward” controls to reach the desired location of the video. Secondly, current computer video players do not incorporate other forms of materials into presentations. For example, if the video mentions a website that the user should visit, the user must stop the video and use a separate Internet browser to manually view the website. Likewise, if the video includes references to other, tangential, content that the user may wish to access—such as other related videos, documents, or music—the user must find that content on his or her own at a later time.

What is needed in the art is a way to incorporate such related information into a video so that the user can freely access it. Such a device should allow the user to easily jump back and forth from the primary video to the tangential content. Such a device should also allow the user to skip any or all of the tangential that is available.

### SUMMARY OF THE INVENTION

One object of the present invention is to provide a method for viewing a presentation that includes tangential content. The tangential content may include other videos, music, documents, websites, etc.

Another object of the invention is to associate the tangential content with the appropriate portion of the primary video. Thus, the user is given access to the tangential content only when it becomes relevant to the presentation.

Yet another object of one embodiment of the invention is to provide a presentation which is divided into a series of steps. Information for each step is readily available to the user without requiring that user to view the entire presentation.

In one embodiment, the present invention is a player for a multimedia presentation, where the presentation includes a video as well as tangential content, such as supporting documents, webpages, and the like. Each segment of tangential content is assigned to a representative slide that will become visible (appear) at a predetermined time or frame in the video. These slides are displayed at set locations near the display region of the video. To access any of the tangential content, the user selects one of the slides and the tangential content is displayed. Control panels may allow the user to control the video and/or tangential content. The display regions for the video as well as the tangential content could also be combined. A presentation script is used to define the interrelationship of the slides, the tangential content, and the video so that presentations having tangential content can be readily created.

Another embodiment of the present invention allows a user to create such a presentation using a video, and a set of tangential content. Such an authoring tool allows the user to associate slides with certain times or frames of the video as well as to associate what tangential content is retrieved for each slide. The output of such an authoring tool is a presentation script.

Other objects and advantages of the present invention will become more apparent to those persons having ordinary skill in the art to which the present invention pertains from the foregoing description taken in conjunction with the accompanying drawings.

### BRIEF DESCRIPTION OF THE DRAWINGS

FIG. 1 is a diagram of one embodiment of the present invention describing the components of a software system for authoring a multimedia presentation.

FIG. 2 is a diagram of one embodiment of a video presentation as displayed to the user.

FIG. 3 is a diagram of one embodiment of the present invention showing the components of a content template for a video presentation.

FIGS. 4 and 5 are flow charts of two embodiments of a method used by a video authoring tool used to prepare a presentation.

FIG. 6 is a diagram of one embodiment of the present invention, showing the components of a content template for a video presentation.

FIG. 7 is a block diagram illustrating the video player architecture.

### DETAILED DESCRIPTION OF THE PREFERRED EMBODIMENTS

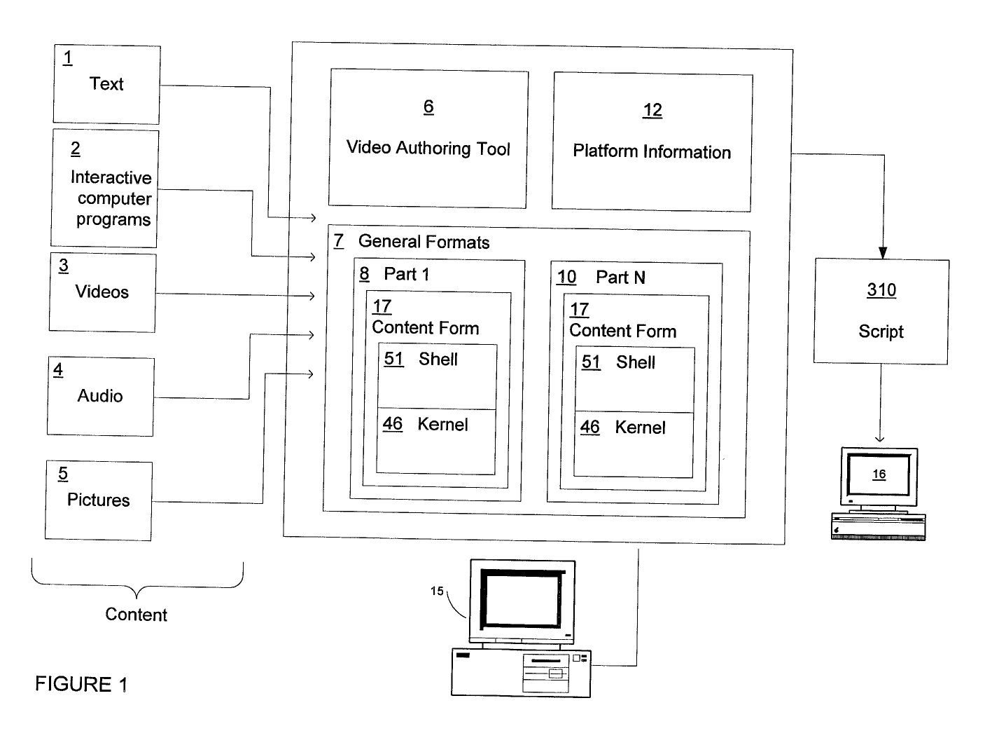

In one embodiment of the invention, the system shown in FIG. 1 can be used by a user to develop a multimedia presentation 13 on a given subject. The method of the present invention uses the computer system to collect pre-existing content, such as audio content 4, video content 3, graphics/pictures 5, text 1, interactive computer programs (such as applets) 2, and other types of multimedia content (such as HTML content).

The various pieces of content (1-5) are collected for input 6 into the video authoring tool 6, which also has access to predefined general formats 7 of video presentations. Each general format specification, such as the exemplary Part 1 specification (8) and Part N specification (10) has its own content requirements, known as the part's content form 17. The content form 17 includes a shell 51, and a kernel 46.

### Content Forms

The content form(s) 17 of the present invention define the format of how the multimedia presentation will be presented to the user. In a given presentation, which may contain videos, text, audio clips, etc., there may be the need for several content forms—one for each type of content to be presented. The video authoring tool 6 creates a presentation interface integrating the multimedia content by using as input both the content forms 17 and the multimedia content 1-5.

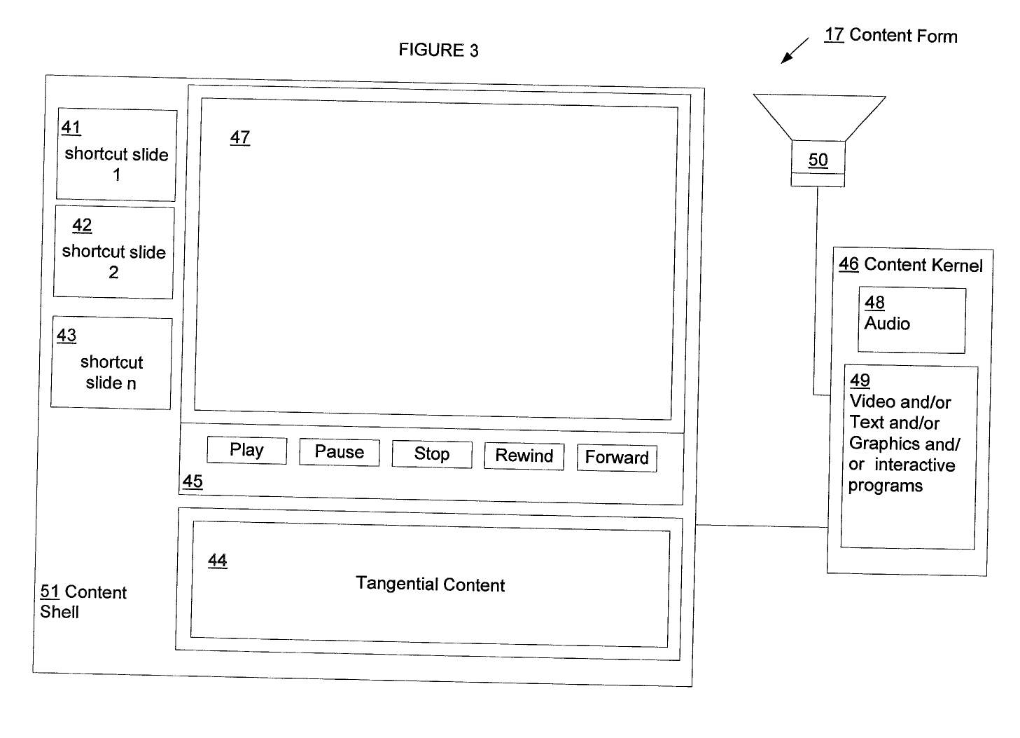

FIG. 3 shows the content form 17 used in displaying a presentation to the user in more detail. As shown in FIG. 3, the content form 17 contains a content shell 51 and a content kernel 46. The content shell 51 is a user interface template for structuring various multimedia content. The content kernel 46 is one or more data files that contains all the necessary multimedia content, in the appropriate formats, for the content shell 51 to use.

The content shell 51, of the content form 17 in FIG. 3 defines a video playing in a main window 47. Commands 45 control the video, accompanying text 44 or other multimedia content and predetermined images in shortcut slides 41-43. The tangential content 44 may be information related to information in the main window 47. As the video is playing, a user may access the tangential content 44. The predetermined images in the shortcut boxes 41-43 are selectable by a user or otherwise “activated automatically” (if so scripted) and may initiate an event. For example, selecting an image may cause a “jump” to a particular scene in the video or may activate other multimedia content in the main window. Alternatively, if so scripted, an event not apparent to the user may take place, such as the billing of a credit card or the compilation and/or submission of user profile information. The content shell 51 also includes an audio source 50. The audio source is an interface to a sound source, such as a speaker.

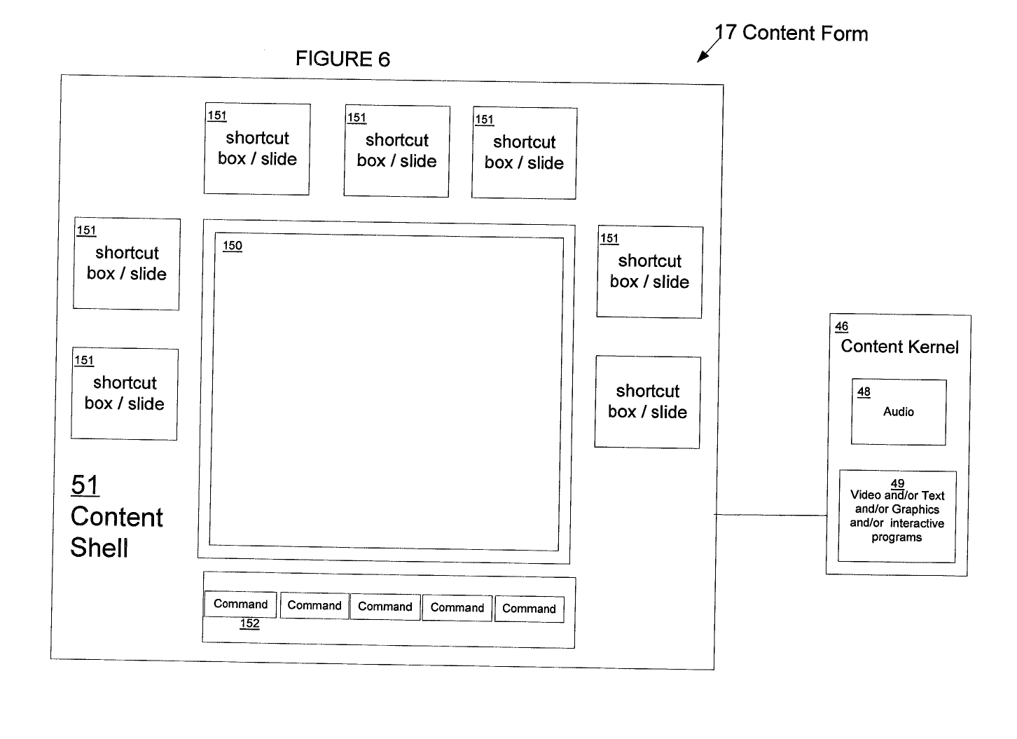

FIG. 6 is an another example content form 17 having a content shell 51 and content kernel 46. This content form 17 again defines a video playing in a main window 150 including video control commands 152. As a video plays in the main window 150, predetermined events start occurring in shortcut slides (also known as boxes) 151 at predetermined times. As an example, the predetermined event may be the appearance of a predetermined image. Once an image appears in a shortcut box 151, the image is selectable by a mouse click or other input method, or alternatively, the slide can auto-select or activate itself if so programmed by a script. When a shortcut slide/box 151 is selected or is automatically activated, the video or other multimedia content executing in the main window 150 pauses and a second, tangential presentation begins. The second presentation can begin in the main window 150 or anywhere else in the content shell 51. The second presentation relates to the concept depicted by the selected event in the shortcut box 151. The second presentation can be of variable format, such as text, video, graphic image, interactive program, web browser, etc. In one exemplary embodiment, the second presentation becomes visible in the main window 150 and another control panel appears in the control command area 152 giving the user navigational control over the second presentation. If the second presentation is text, the user may be able to use scrolling, paging and other text control buttons. If the second presentation is a video the user may be given another set of video control buttons.

### Filling in the Content Shell: Video Authoring Tool

The content forms 17 represented by FIG. 3 and FIG. 6 are just two exemplary ways of structuring the multimedia content for presentation to a viewer. The content shell 51 defines a main window 47, and n-number of shortcut boxes or slides 41, 42, 43, which “jump” to particular playback points in the video 49 stored in the content kernel 46. FIG. 3 shows, by way of example, three shortcut slides 41-43. It is important to note that the video playback during content editing is different from that of the video playback in the content shell as seen by a viewer during the presentation. It is to be understood that there may be any number of shortcut slides, and they may be structured in various graphical ways in the content shell 51.

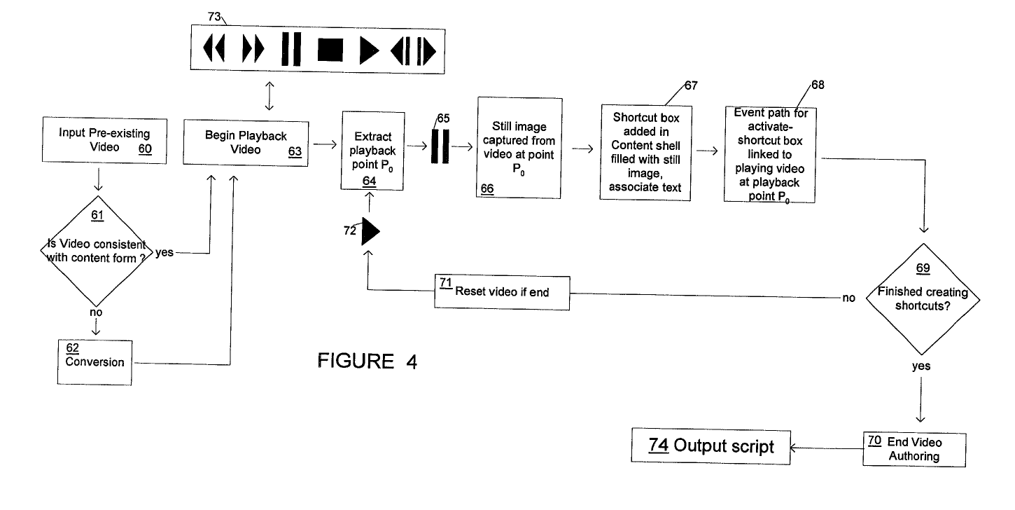

FIG. 4 illustrates an exemplary method for creating a presentation script which will direct a multimedia presentation for the content shell in FIG. 3 where the shortcut slides in the content shell 51 link predetermined multimedia images or text to playback points of the video. In the present embodiment, the author of a new presentation first inputs a pre-existing video 60 into the video authoring tool. The video begins to play and the author may, at any time, use video controls 73 to control the video, such as with controls to fast forward, reverse, pause, stop, play, or play in slow motion. In FIG. 4, the controls are graphically shown with their common symbols.

At any desired point in the video, the author may choose and extract a playback point P0 (or frame) from the video 64. The playback of the video during content authoring is then paused 65 and a shortcut slide in the content shell 51 is associated with the playback point P0. A still image of the video at the playback point is captured 66 and the shortcut slide in the content shell 51 is filled with the captured image 67. The author may also associate tangential content (such as text or a clipped video segment) with the added shortcut slide. A specific event is then chosen 68 for activation of the shortcut slide. For example, a shortcut slide may be activated during execution if a user clicks on it with a mouse or uses some other input method, or alternatively it can be activated automatically if so programmed by the presentation script. In the exemplary embodiment illustrated in FIG. 4, the event path for activation of the shortcut slide is linked to playing the video in the main window at the playback point P0. If the author is finished with adding shortcut slide, the video editing ends 70 and a presentation script is generated which can later be used by a video player to play the presentation. Otherwise, the playback resumes 71 and 72.

Once the video authoring tool of FIG. 4 constructs a multimedia presentation, a user may later play it. To do so, the user accesses the content shell 51 of FIG. 3 and uses the controls 45 to cause the video 49 to begin. In some embodiments, as the user progresses through the video 49 to the various playback points pre-associated with shortcut slides (41, 42, etc.), then the shortcut slide appears in the content shell 51. Thus, by the end of the video, all of the associated shortcut slides are displayed. This allows the user to easily jump back to critical points in the video 49 by simply selecting the appropriate slide.

Some embodiments of the present invention present to the user a multimedia “floating steps” presentation. Such a presentation teaches the user a procedure, which is made up of a series of steps. For each step in the procedure, a shortcut slide is created. Thus, the user can choose to play the video from start to finish to learn the procedure in its entirety. Then, the user can repeat the instructions for certain steps by selecting the appropriate slide. This causes the video to jump to the proper point for that step. Alternatively, if the user already has some knowledge about the procedure at hand, the user can decide not to play the video directly, but rather to simply jump to the portions of the video explaining the unfamiliar steps by selecting the appropriate slides.

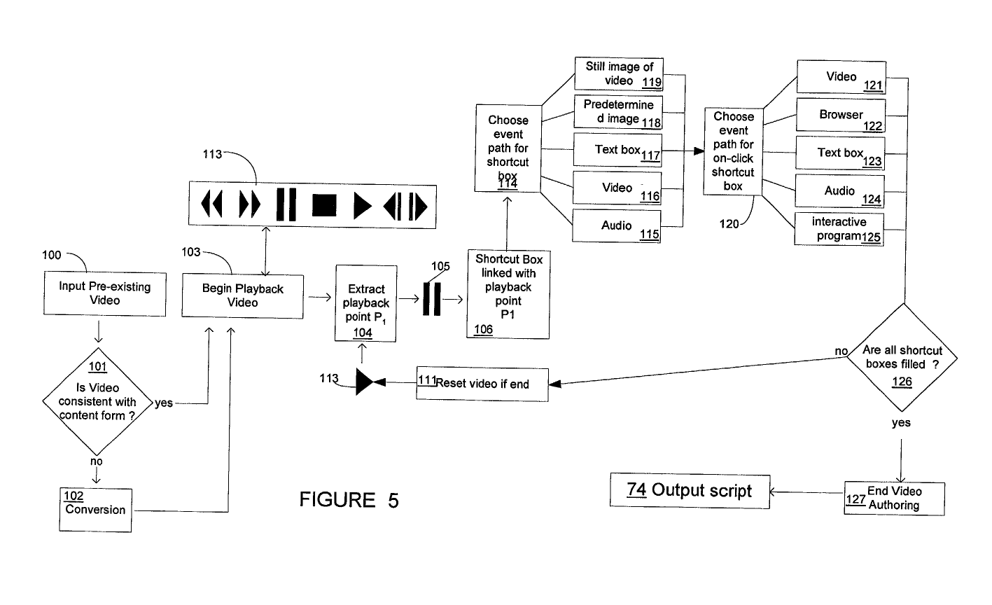

FIG. 5 illustrates another version of authoring a presentation. In FIG. 5, the flowchart represents multimedia content editing of a content shell where the shortcut boxes in the content shell link to other tangential content. In the present embodiment, a pre-existing video is first input 100 into the content generation application 14 during content editing. The video begins to play 103 and the author may, at any time, use video controls 113 to fast forward, reverse, pause, stop, play, or play in slow motion the video.

At any desired point in the video, the author may extract a playback point P1 from the video 104. The playback of the video during content authoring is then paused 105 and a shortcut box/slide in the content shell is linked 106 to the playback point P1. In one embodiment, linking a shortcut slide to the playback point P1 will cause during video playback in the content shell, an event will occur in the shortcut slide whenever the video reaches the playback point P1. A specific event is then chosen 114 for the shortcut box. The author may choose from a variety of event paths that will execute at the point P1 during video playback in the content shell. Exemplary event paths may include, but are not limited to, the appearance of the still image of the video 119 taken at P1, the appearance of a predetermined image 118, an interactive text box 117, another video 116, or an audio program 115 standing alone or in combination with any other event path or a web browser. For example, as illustrated in FIG. 6, if the event path chosen is the still image of the video 119, then during playback of the video, the still shot of the video taken at playback point P1 during content authoring will appear in the shortcut box at point P1 during playback in the content shell.

The activation of the shortcut box may then be linked with another event 120, such as a predetermined video 121 or other form of tangential content. In such a situation, while viewing the presentation, if the viewer activates the shortcut box 151 by clicking on it, or by some other input method, the predetermined video 121 begins to play in the content shell. In some embodiments, the tangential content displays in a region reserved for such content 44 so that the main window 47 can continue to display the primary video. A user may link the activation of the shortcut box 120 with a variety of events, such as, but not limited to, activating an interactive program 125, a web browser 122 which may be embedded in the content shell, an interactive text box 123, or an audio program 124 alone or in conjunction with one of the other event paths.

The video authoring tool not only associates tangential content with the slides, but it also assists the user in the creation of content. For example, in one embodiment, the authoring tool includes an HTML editor that the user can use to create HTML tangential content, while in another embodiment, the authoring tool may include a function that defines a quiz, allowing the user to associate a quiz to the content.

Once the author is finished creating shortcuts 126, the video editing ends 127. Otherwise, the playback resumes 111, 113. Once again, the end of editing results in a presentation script being generated that can later be used to run the presentation.

### Script-Based Multimedia Presentations

As discussed above, FIGS. 4 and 5 illustrate methods for authoring multimedia content presentations with tangential content. These presentations can later be shown to a user with a presentation player. The presentations built through the methods of FIGS. 4 and 5 are based upon a presentation script generated during the authoring process. Thus, the elements of the presentations are: the video file, images or text for the short cut slides, tangential content associated with the shortcut slides, and the presentation script which describes the relationships among the video, slides, and tangential content. Once created, a multimedia player can play the presentation to a user by parsing the presentation script.

In one preferred embodiment, the video authoring tool and the video player are written in Java (or other similar language) to allow the tools to be platform independent. The video presentation script is generated in VXML (“Video Extensible Markup Language), a markup language that is compliant with XML. As is well known in the art, Extensible Markup Language, otherwise known as XML, is a universal format for structured documents and data on the Web. XML allows for the creation of textual data files delimited by markup tags. XML is a World Wide Web Consortium (“W3C”) standard and information on it can be found on W3C's website. As XML is—by its very name—extensible, various parties have created implementations of the language for specific purposes. For example, there is VoiceXML, IXML, and FXML, to name just a few. VoiceXML (also known as VXML, but not to be confused with the VXML of the present invention) is the speech interface framework that extends the Web to voice-based devices. The International Consortium for Alternative Academic Publication (“ICAAP”) has developed IXML, which promises to provide sophisticated indexing and document handling capabilities at a very low cost. And OANDA Corporation supports FXML as a simple, automatic way of retrieving currency exchange rates over the Internet. The present invention includes VXML as yet another useful extension of XML.

In the present invention, the video player parses the video presentation VXML script and reacts accordingly to properly present the video, the shortcut slides, and the tangential content associated with the shortcut slides. In the preferred embodiment, any new type of tangential content type can be handled by a “plugin”-type system where the code to display and to execute the new content type is dynamically attached to the presentation player program. With this method, the presentation player can be extended to handle an infinite number of different tangential content types. One of ordinary skill in the art is familiar with such “plugin”-type architecture.

Although scripting languages are well known in the art, VXML is more robust that other similar languages. For example, VXML supports Boolean testing, branching, variable storage, resource allocation, subroutines, and the like.

As in XML, VXML is a series of tags that can be used to categorize and define a set of data. At the highest level, every VXML script has a similar structure. All such scripts begin with the <VXML> tag followed by all resource-type tags within a RESOURCES section followed by one or more SEQUENCE sections composed of frame-type tags. Each of the sequence sections is parsed by the frame player module of the video player when called, beginning with the sequence section labeled as “main” so that the presentation can be correctly played for the user.

In a preferred embodiment, VXML is made up of three primary types of tags: Section tags, Resource tags, and Sequence tags. Each type supports a set of tags. A 5 preferred embodiment of the syntax for the various tags will now be described.

(1) Section Tags

Section tags provide a framework for organizing the VXML script as a whole. In one embodiment, there are three Section tags: (i) <VXML>, (ii) <RESOURCES>, and (iii) <SEQUENCE>.

(a) <VXML> SECTION TAG

The <VXML> tag is the first tag in every VXML presentation script file and it encapsulates all of the remainder of the script file. Thus, a VXML script file can be placed within another XML or HTML file. If that file does not recognize the VXML tag, the entire VXML portion will be ignored. The syntax of this tag is:

<VXML: w=width_value h=height_value>

where the width_value value determines the width of the video player and the height_value value determines the height of the video player.

(b) <RESOURCES> SECTION TAG

The <RESOURCES> tag delineates the resources section of the VXML file. Each resource, such as a video, is given a name and may be otherwise described. The <RESOURCES> tag must be supplied in every VXML file and it must appear as the first tag after the <VXML> tag.

(c) <SEQUENCE> SECTION TAG

Following the <RESOURCES> tag are one or more <SEQUENCE> tags. Each <SEQUENCE> tag groups together a collection of <FRAME> tags. The resulting sequence of Frames may be “played” by a Call Frame. The first of the <SEQUENCE> tags must be named “main” and it will execute first. The Call Frame may optionally set values for variable data values, which may be referenced by the Frames of the sequence.

For example the <SEQUENCE> tag may be in the form of:

```
<SEQUENCE: name=my_sequence, parm0=time_to_start,
parm1=time_to_end>
  <IMAGE: time=$time_to_start,
  url=file:///c:\images\face.jpg, region=my_region>
  </IMAGE>
  <WAIT: time=$time_to_end> </WAIT>
</SEQUENCE>
```

In this example, a sequence named “my_sequence” is created. Two parameters are created via variables named time_to_start and time_to_end. The Image Frame and the Wait Frame each reference one of these variables. The actual values of the variables will be determined at run-time by a Call Frame.

(2) Resource Tags

Resource tags define time-less resources that are global in nature, such as tools, resources, or structures that may be accessed by various and multiple sequence tags. Currently there are four supported Resource tags: <REGION>, <VIDEO>, <STYLE>, and <VARIABLE>.

(a) <REGION> RESOURCE TAG

The <REGION> tag is used to define an area of the screen. This tag defines a region of the screen that may be referenced by various Frame Tags. Each region is given a name, position, and dimensions. There may be many Region Tag's, and the regions that they specify may overlap. The syntax for this tag is:

| | |
|---|---|
| <REGION: | name=region_name, |
| | x=x_value, y=y_value, w=width_value, |
| | h=height_value> |
| </REGION> | |

where: region_name is any author-selected name for the region;

X_value indicates the x coordinate of the upper left corner of the named region;

Y_value indicates the y coordinate of the upper left corner of the named region;

Width_value indicates the width of the named region; and

Height_value indicates the height of the named region.

(b) <VIDEO> RESOURCE TAG

The <VIDEO> tag is used to define a video that may be by referenced by one or more Video Frame Tag's. Each video is given a name, and assigned to a named region. Videos will not be displayed until an appropriate Video Frame is executed. The syntax of this tag is:

<VIDEO: name=video_name, url=locator_value,
region=region_name>
</VIDEO>

where: video_name is any author-selected name for the video;

locator_value is the url of the file containing the video data; and

region_name is any named region defined by a Region Tag.

(c) <STYLE> RESOURCE TAG

The <STYLE> tag defines the format, color, and styles used by various Frame tags. There is a pre-defined Style Resource, with all default parameter values. All Frames whose style parameters are null use the default Style Resource. The syntax for this tag is:

| | |
|---|---|
| <STYLE: | name=style_name, |
| | bcolor=background_color_value, |
| | fcolor=foreground_color_value, |
| | font_name=font_name_value, |
| | font_style=font_style_value, |
| | font_size=font_size_value, |
| | border=border_flag, |
| | border_title=border_title_flag, |
| | border_color=border_color_value, |
| | align=alignment_value> |
| </STYLE> | |

where: Style_name is any author-selected name for the style;

Background_color_value, foreground_color_value and border_color_value are any of the following: black, blue, cyan, dark gray, gray, green, light gray, magenta, orange, pink, red, white, yellow;

font_name_value is the name of any installed font;

Font_style_value is any of the following: bold, italic, plain or regular;

font_size_value is any size that is valid for the specified font;

Border_flag is either 0 or 1, to indicate the absence or presence of a border;

Border_title_flag is either 0 or 1, to indicate the absence or presence of a border title; and

Alignment_value is one of the following: center, left, right, trailing, or leading.

(d) <VARIABLE> RESOURCE TAG

The Variable Resource provides a global mechanism for passing and storing data. Variable Resource values can be set via a SET Frame, and interrogated via an IF Frame. Clearing a Variable Resource via a CLEAR Frame sets it value back to the specified initial value.

Variable Resources should not be confused with Sequence Variables, which may be passed to Sequences via the Call Frame. The values of Sequence Variables are only valid within the Sequence in which they are defined. In particular, except via a Call Frame, there is no way for a Frame in one Sequence to set the value of a Sequence Variable for a Frame in a different Sequence; Variable Resources, however, are global in nature. Once a Variable Resource is set via a Set Frame, its value can be checked by If or Until Frames in any Sequence.

The syntax for a <VARIABLE> tag is:

<VARIABLE: name=variable_name, initial=initial_value>
</VARIABLE>

where: Variable_name is any author-selected name for the variable; and

Initial_value is any alphanumeric value, which will be the default value assigned to the variable.

(3) Sequence Tags, Also Known As Frame Tags

Sequence tags within a VXML script define the actions and events that comprise a presentation. Each sequence tag defines an action or presentation element and the time at which it is to occur. Sequence tags are also called “Frame Tags” or “Frames” since frames in a movie similarly define presentation elements (i.e., the images) that occur at specific times.

Currently, there are fourteen supported Frame tags in VXML, from the VIDEO tag which executes the specified command (such as “play”) on the video, to the IF tag which performs a conditional test on a variable resource.

(a) <VIDEO> FRAME TAG

The VIDEO Frame tag executes the specified command on the specified video. If the command is play, then video playback begins at the specified media-time. If the command is stop, then the video is stopped, and the still frame associated with the specified media-time is displayed. The video is displayed in the screen region that was specified in the associated Video Resource. Syntax for this tag is:

<VIDEO: time=$time_value, video=$video_name,
cmd=$video_cmd, media_time=$position_value>
</VIDEO>

where: time_value is the time, in milliseconds, at which the Video Frame will be executed;

video_name is the name of a video (should match a name that was specified in a Video Resource);

video_cmd is either play or stop; and

Position_value specifies the media time for the specified video command (a media time of minus one indicates that the video should start/stop wherever it is);

(b) <IMAGE> FRAME TAG

The IMAGE Frame displays the specified image in the specified region. The x, y, w, and h parameters facilitate the use of a “cropped” file. That is, the specified image file may contain a large image; but only the rectangle specified by the parameters will be displayed. If negative values are specified for the width or height parameters, then the entire width or height of the image is used. The general syntax for this tag is:

```
<IMAGE: time=$time_value, url=locator_value,
  region=$region_name, x=x_value, y=y_value,
  w=width_value. h=height_value >
</IMAGE>
```

where: time_value is the time, in milliseconds, at which the Image Frame will be executed;

locator_value is the url of the file containing the image data, in JPEG format;

region_name is the name of a region (should match a name that was specified in a Region Resource);

x_value indicates the x coordinate of the upper left corner of the image within the image file;

y_value indicates the y coordinate of the upper left corner of the image within the image file;

width_value indicates the width of the image within the image file; and

height_value indicates the height of the image within the image file.

(c) <SCRIPT> FRAME TAG

The SCRIPT tag displays the specified html data in the specified region. If the URL is null, then the in-line content is displayed. Otherwise, the content is taken from the specified URL. The syntax for this tag is:

| | |
|---|---|
| <SCRIPT: | time=$time_value, url=$locator_value, |
| | region=$region_name, style=$style_name> |
| | optional html content |
| </SCRIPT> | |

where: time_value is the time, in milliseconds, at which the Script Frame will be executed;

locator_value is the url of the file containing the script data, in html format;

region_name is the name of a region (should match a name that was specified in a Region Resource); and

style_name is the name of a style (should match a name that was specified in a Style Resource).

(d) <LABEL> FRAME TAG

The Label Frame displays the specified text as a label within the specified region. If the url is not null, then an icon will also be displayed within the label. The syntax is:

```
<LABEL: time=$time_value, url=$locator_value,
  region=$region_name, style=$style_name,
  align=$text_to_icon_alignment >
label_text
</LABEL>
```

where: time_value is the time, in milliseconds, at which the Label Frame will be executed;

locator_value is the url of a file containing an image to be displayed as an icon within the label;

region_name is the name of a region (should match a name that was specified in a Region Resource);

style_name is the name of a style (should match a name that was specified in a Style Resource); and

text_to_icon_alignment is one of: top, bottom, left, right, or center.

(e) <CLEAR> FRAME TAG

The Clear Frame causes the specified Resource to revert to a “clear state”. The exact meaning of “clear state” is dependent on the particular Resource. For a Region Resource, the clear state is one in which the associated screen region is erased. For a Video Resource, the clear state is one in which the video is stopped and the associated screen region is erased. For a Style Resource, the clear state has no meaning. Syntax for this tag is:

<CLEAR: time=$time_value,
resource=$resource_name> </CLEAR>

where: time_value is the time, in milliseconds, at which the Clear Frame will be executed; and

resource_name is the name of a resource (should match a name that was specified in a Resource Tag).

(f) <WAIT> FRAME TAG

The Wait Frame performs no operation. Including a Wait Frame in a Sequence has the effect of causing the sequence to wait until time in the specified time parameter has passed. The syntax for the tag is:

<WAIT: time=$time_value> </WAIT>

(g) <SET> FRAME TAG

The Set Frame sets the value of the specified Variable Resource. Once set, the value of the Variable Resource is available to IF and UNTIL Frames in all Sequences. The syntax for this tag is:

<SET: time=$time_value, variable=$variable_name,
value=$new_value> </SET>

where: time_value is the time, in milliseconds, at which the Set Frame will be executed; and

Variable_name is the name of a Variable (should match a name that was specified in a Variable Resource Tag).

(h) <UNTIL> FRAME TAG

The Until Frame stalls the currently executing Sequence until the specified condition is, or becomes true. Until that occurs, no subsequent Frames will be played. However, Asynchronous Frames, resulting from user interaction with Button Frames or Entry Frames may execute while the Sequence is stalled. Presumably in this manner the specified condition will eventually be made to be true via a Set Frame, so that the Sequence may continue. The syntax for this tag is:

| | |
|---|---|
| <UNTIL: | time=$time_value, variable=$variable_name, |
| | test=$condition, value=$test_value> |
| </UNTIL> | |

where: time_value is the time, in milliseconds, at which the Until Frame will be executed;

variable_name is the name of a Variable; (should match a name that was specified in a Variable Resource Tag);

Test is one of: equal, not_equal, greater_than, less_than, greater_than_or_equal, or less_than_or_equal; and

value is an alphanumeric value to which the specified Variable Resource will be compared.

(i) <SLIDER> FRAME TAG

The Slider Frame tag displays a “slide-control” in the specified Region. The slide-control can be used to change the time during a video presentation. That is, this control allows a user to fast-forward, rewind, or skip over sections of an presentation. The Slider Frame can only change the time within the Sequence in which it is found, (its “home” Sequence), and any Sequences invoked via Call Frames that are executed within its “home” Sequence. The syntax for this tag is:

<SLIDER: time=$time_value, region=$region_name> </SLIDER>

where: time_value is the time, in milliseconds, at which the Slider Frame will be executed; and

region_name is the name of a region.

(j) <CALL> FRAME TAG

The Call Frame tag invokes the specified Sequence. After the Frames that comprise the content of the called Sequence are played, execution continues with the Frame after the Call Frame. The syntax for this tag is:

| | |
|---|---|
| <CALL: | time=$time_value, sequence=$sequence_name, |
| | parm0=$parm0_value, parm1=$parm1_value, |
| | parm2=$parm2_value, parm3=$parm3_value, |
| | parm4=$parm4_value, parm5=$parm5_value, |
| | parm6=$parm6_value, parm7=$parm7_value, |
| | parm8=$parm8_value, parm9=$parm9_value > |
| </CALL> | |

where: time_value is the time, in milliseconds, at which the Call Frame will be executed; sequence_name is the name of a Sequence (should match a name that was specified in a Sequence Section Tag); and

ParmX_value is a value to be assigned to the X'th Sequence Variable of the called Sequence. The Frames that comprise the content of the called Sequence may retrieve the value of the X'th Sequence Variable by the variable name associated with the X'th parameter in the Sequence Section Tag, prefixed by a dollar sign.

(k) <BUTTON> FRAME TAG

The BUTTON Frame, once it is executed, causes a specified region to become sensitive to mouse clicks. From this time on, if a mouse click occurs within the specified region, then the Button Content Frame is executed immediately. When the mouse click occurs (the activation time), the Button Content Frame will be played without regard to any time parameter, even if the video player is waiting on the condition of an Until Frame. The syntax for this tag is:

<BUTTON: time=$time_value, region=$region_name>
A single frame tag, (the Button Content Frame)
</BUTTON>

where: time_value is the time, in milliseconds, at which the button tag will be executed. (i.e., the time at which the region will become sensitive to mouse-clicks); and

region_name is the name of a region (should match a name that was specified in a Region Resource).

(l) <ENTRY> FRAME TAG

The Entry Frame, once it is executed, allows the viewer of the video presentation to enter data. In order to begin entering data the user need only place the mouse cursor within the designated region, and begin typing. Upon pressing the enter-key any entered text is transferred to a special variable. When the enter-key is pressed (the activation time), the Entry Content Frame will be played without regard to any time parameter, even if the video player is waiting on the condition of an Until Frame. The syntax for this tag is:

<ENTRY: time=time_value, region=region_name,
style=style_name, name=text_variable_name>
A single frame tag (the Entry Content Frame)
</ENTRY>

where: time_value is the time, in milliseconds, at which the Entry Frame will be executed;

region_name is the name of a region (should match a name that was specified in a Region Resource);

style_name is the name of a style (should match a name that was specified in a Style Resource); and

Text_variable_name specifies the name of a variable to hold the entered text.

(m) <IF> FRAME TAG

The If Frame performs a test on the specified Variable Resource. Depending on the outcome of the test, the If Frame either executes, or does not execute the If Content Frame. If the Resource Variable “passes” the specified test then the If Content Frame will be executed immediately, and before the next Frame in the Sequence. If the test passes, then the If Content Frame will be played without regard to any time parameter. The syntax for this tag is:

<IF: time=time_value, variable=$variable_name,
test=$condition, value=$test_value>
A single frame tag (the If Content Frame)
</IF>

where: time_value is the time, in milliseconds, at which the Entry Frame will be executed;

variable_name is the name of a Variable (should match a name that was specified in a Variable Resource Tag);

Test is one of: equal, not_equal, greater_than, less_than, greater_than_or_equal, or less_than_or_equal; and

value is an alphanumeric value to which the specified Variable Resource will be compared.

(n) <NEW> FRAME TAG

The NEW tag, once it is executed, causes the video player to load and play a new presentation for the user. The syntax of this tag is:

<NEW: time=$time_value, url=$locator_value> </NEW>

where: time_value is the time, in milliseconds, at which the NEW tag will be executed; and

locator_value is the url of a new (compiled) presentation file for the video player to play.

### Operation of the Video Player

As has been previously discussed, FIGS. 4 and 5 demonstrate the method of video authoring in which a video presentation is associated to a series of slides, each slide displaying tangential content, allowing the user to jump to a location within the video, or allowing to user to access tangential content. The end result of video authoring is a presentation script. In the preferred embodiment, the presentation script is a VXML script, although other formats could also be used.

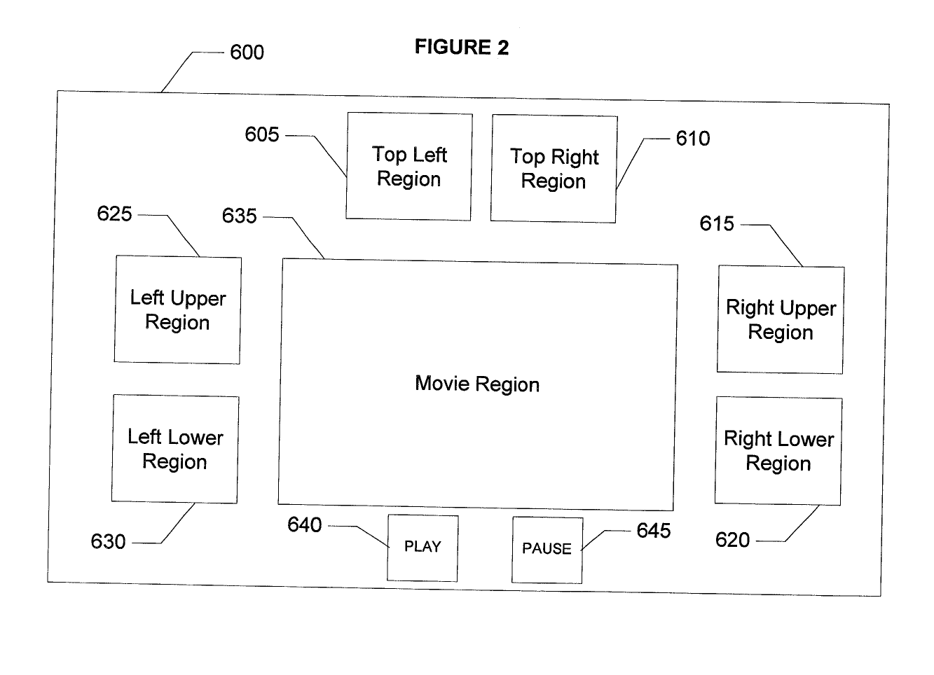

When the video player application begins execution, it parses a VXML presentation script that describes the relationships among the video, the slides, and the tangential content. By way of example, in one embodiment, a system using the methods shown in FIGS. 4 and 5 can create the following presentation script file that will cause the user interface illustrated by FIG. 2 to be presented to the user:

```
<VXML>
<RESOURCES>
  <REGION: name=“slide_top_left” x=“220” y=“10” width=“100”
height=“100” >
  </REGION>
  <REGION: name=“slide_top_right” x=“330” y=“10” width=“100”
height=“100” >
  </REGION>
  <REGION: name=“slide_right_upper” x=“530” y=“130” width=“100”
height=“100” >
  </REGION>
  <REGION: name=“slide_right_lower” x=“530” y=“250” width=“100”
height=“100” >
  </REGION>
  <REGION: name=“slide_left_upper” x=“10” y=“130” width=“100”
height=“100” >
  </REGION>
  <REGION: name=“slide_left_lower” x=“10” y=“250” width=“100”
height=“100” >
  </REGION>
  <REGION: name=“movie_rect” x=“160” y=“120” width=“320”
height=“240” >
  </REGION>
  <REGION: name=“play_butt_rect” x=“260” y=“360” width=“50”
height=“50” >
  </REGION>
  <REGION: name=“pause_butt_rect” x=“330” y=“360” width=“50”
height=“50” >
  </REGION>
  <VIDEO: name=“main_movie” url=“http://l3i.com/main.mov”
region=“movie_rect” >
  </VIDEO>
  <VIDEO: name=“sub_movie” url=“http://l3i.com/tangential1.mov”
region=“movie_rect” >
  </VIDEO>
  <VARIABLE: name=“slide_done” initial=“0” >
  </VARIABLE>
</RESOURCES>
<SEQUENCE name=“main” >
  <IMAGE: time=“0” url=“play_butt.jpg” region=“play_butt_rect” >
  <BUTTON: time=“0” region=“play_butt_rect”>
    <VIDEO: name=“main_movie” cmd=“play” >
    </VIDEO>
  </BUTTON>
  <IMAGE: time=“0” url=“pause_butt.jpg” region=“pause_butt_rect” >
  <BUTTON: time=“0” region=“pause_butt_rect”>
    <VIDEO: name=“main_movie” cmd=“stop” >
    </VIDEO>
  </BUTTON>
  <VIDEO: name=“main_movie” time=“0” cmd=“play”
media_time=“0” >
  </VIDEO>
  <IMAGE: time=“5000” url=“slide1.jpg” region=“slide_top_left” >
  </IMAGE>
  <BUTTON: time=“5000” region=“slide_top_left”>
    <CALL: sequence=“show_html_text”
text_file_name=“slide1.html” >
    </CALL>
  </BUTTON>
  <IMAGE: time=“8000” url=“slide2.jpg” region=“slide_top_right” >
  </IMAGE>
  <BUTTON: time=“8000” region=“slide_top_right”>
    <CALL: sequence=“show_sub_movie” movie_name=
    “sub_movie” >
    </CALL>
  </BUTTON>
  <IMAGE: time=“11000” url=“slide3.jpg” region=
  “slide_right_upper” >
  </IMAGE>
  <BUTTON: time=“11000” region=“slide_right_upper”>
    <CALL: sequence=“show_image” image_file_name=
    “image_abc.jpg”>
    </CALL>
  </BUTTON>
  <IMAGE: time=“14000” url=“slide4.jpg” region=
  “slide_right_lower” >
  </IMAGE>
  <BUTTON: time=“14001” region=
  “slide_right_lower”>
    <CALL: sequence=“show_sub_movie” movie_name=
    “sub_movie” >
    </CALL>
  </BUTTON>
  <IMAGE: time=“17000” url=“slide5.jpg” region=“slide_left_lower” >
  </IMAGE>
  <BUTTON: time=“17000” region=“slide_left_lower”>
    <CALL: sequence=“show_html_text”
    text_file_name=“slide5.html” >
    </CALL>
  </BUTTON>
  <IMAGE: time=“20000” url=“slide5.jpg” region=“slide_left_upper” >
  </IMAGE>
  <BUTTON: time=“20000” region=“slide_left_upper”>
    <CALL: sequence=“show_image” image_file_name=
    “image_abc.jpg”>
    </CALL>
  </BUTTON>
</SEQUENCE>
<SEQUENCE: name=“show_html_text” parm0=“text_file_name” >
    <SET: variable=“slide_done” value=“0”>
    </SET>
    <VIDEO: name=“main_movie” cmd=“stop” >
    </VIDEO>
    <VIDEO: name=“main_movie” cmd=“hide” >
    </VIDEO>
    <SCRIPT: time=“5001” region=“movie_rect” url=
    $text_file_name>
    </SCRIPT>
    <BUTTON: region=“movie_rect” >
      <SET: variable=“slide_done” value=“1” >
      </SET>
  </BUTTON>
  <UNTIL: variable=“slide_done” test=“equal” value=“1”>
  </UNTIL>
  <VIDEO: name=“main_movie” cmd=“show” >
  </VIDEO>
  <VIDEO: name=“main_movie” cmd=“play” >
  </VIDEO>
</SEQUENCE>
<SEQUENCE: name=“show_sub_movie” parm0=“movie_name” >
    <SET: variable=“slide_done” value=“0”>
    </SET>
    <VIDEO: name=“main_movie” cmd=“stop” >
    </VIDEO>
    <VIDEO: name=“main_movie” cmd=“hide” >
    </VIDEO>
    <VIDEO: name=$movie_name cmd=“play” >
    </VIDEO>
    <BUTTON: region=“movie_rect” >
      <SET: variable=“slide_done” value=“1” >
      </SET>
    </BUTTON>
    <UNTIL: variable=“slide_done” test=“equal” value=“1”>
    </UNTIL>
    <VIDEO: name=$movie_name cmd=“stop” >
    </VIDEO>
    <VIDEO: name=“main_movie” cmd=“show” >
    </VIDEO>
    <VIDEO: name=“main_movie” cmd=“play” >
    </VIDEO>
</SEQUENCE>
<SEQUENCE: name=“show_image” parm0=“image_file_name” >
    <SET: variable=“slide_done” value=“0”>
    </SET>
    <VIDEO: name=“main_movie” cmd=“stop” >
    </VIDEO>
    <VIDEO: name=“main_movie” cmd=“hide” >
    </VIDEO>
    <IMAGE: name=$image_file_name region=“movie_rect” >
    </IMAGE>
    <BUTTON: region=“movie_rect” >
      <SET: variable=“slide_done” value=“1” >
      </SET>
    </BUTTON>
    <UNTIL: variable=“slide_done” test=“equal” value=“1”>
    </UNTIL>
    <VIDEO: name=“main_movie” cmd=“show” >
    </VIDEO>
    <VIDEO: name=“main_movie” cmd=“play” >
    </VIDEO>
</SEQUENCE>
</VXML>
```

The script above defines a presentation containing a video in the center 635, six slides (605-630) that appear at predetermined times around the perimeter of the video it plays, and instructions specifying what to do when those slides are selected.

First the resources are added. Several regions that comprise the slide positions are added, they are descriptively named; “top_left” 605, “top_right” 610, “right_upper” 615, “right_lower” 620, “left_lower” 625, “left_upper” 630. Then the movie region 635 is added followed by a region for one “sub_movie” (also 635) and two buttons (640 and 645). The movie region 635 is where the main presentation movie will play, the sub movie region (also 635) is where a “tangential” movie will play, and the two button regions (640 and 645) are where the user will click to control the playback of the movie by starting and stopping it.

After the resources, the main sequence follows. First it displays the two movie control button images (“play_butt.jpg” and “pause_butt.jpg”) and declares the two “button” frames enabling the “play” and “pause” movie control. It then tells the main movie to start playing with a “VIDEO” frame. After the video plays for 5 seconds (5000 milliseconds), the first slide is displayed and its associated button becomes active (by the declaration of the button frame). Notice in the button frame, the instruction calls a sequence called “show_html_text”. This means that if a user clicks on the button, then that sequence will be called and the instructions in that sequence will be executed. The “show_html_text” sequence will pause the main video, hide it, then show some HTML text in the main movie window. (The HTML text file name is a parameter to the sequence and in this case it is a file called “SLIDE1.HTML”). It will then wait until the user clicks in that window and then return to the main movie. Upon the return to the main movie, the movie continues and the other slides appear. Slides 2 through 6 appear in the same fashion at 8, 11, 14, 17 and 20 seconds, respectively, into the main movie. Although the slides appear in the same fashion, they have different behaviors when clicked on. Clicking on Slide 2 will call a sequence (“show_sub_movie”) that pauses and hides the main movie, then shows a different movie. Slide 3 will call a sequence (“show_image”) that pauses and hides the main movie, then shows an image.

One skilled in the art will readily see that the presentation script allows the multimedia presentation (with its primary video and tangential content) to be easily built and later modified. By simple changes to the presentation script, different content can be incorporated into the presentation. Also, by simple changes to the presentation script, different topologies can be defined. For example, the video window can appear in the corner with the slides appearing down the side. The way the script is defined enables the linking of any “tangential” content to media playback. In a preferred embodiment, if a new type of content is defined, the player can be extended and a new VXML tag can be added. Also in a preferred embodiment, the player will be built to extend itself to handle a previously undefined tag by accessing a module of code that can dynamically attach to the main body of the player code using a “plug in” system.

In another variation, the slide regions could correspond to steps within an activity. The slide regions could then cause the video in the video window region 1130 to jump to the portion of the video describing the first step if the top left region slide 1110 is selected, and jump to the portion of the video describing the second step (if the top right region slide 1120 is selected. As yet another variation, rather than displaying a graphic image retrieved from a URL, the slide regions 1110 and 1120 can be configured to display any other type of tangential content, such as text, secondary videos, access to websites, audio clips, etc. While the current script gives the user the ability to stop and start the playing of the video by selecting the buttons, in other variations, the video player can present to the user a control panel with controls such as fast-forward, pause, and rewind.

### Architecture of the Video Player

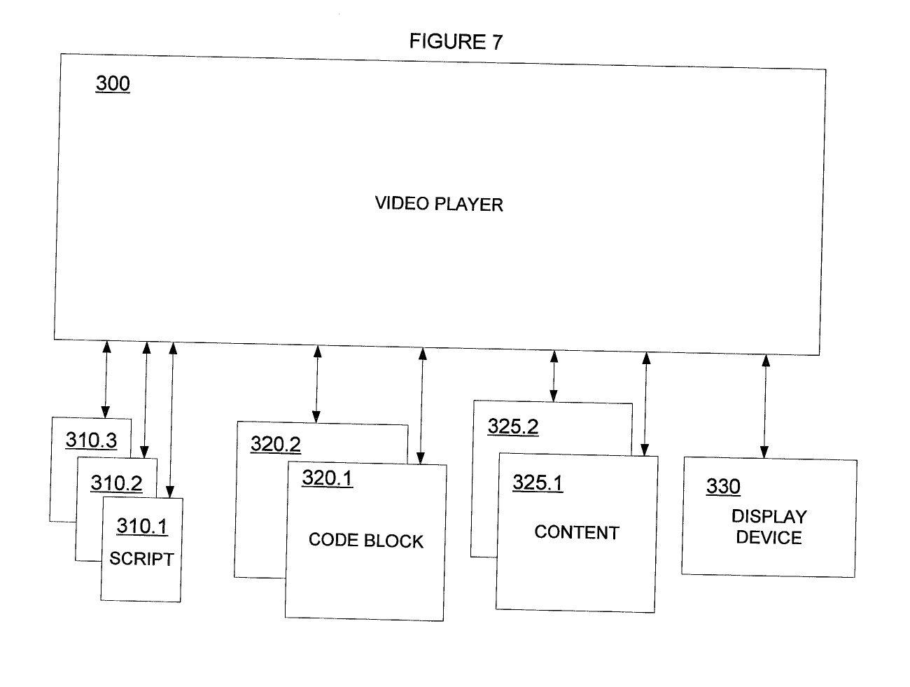

FIG. 7 is a block diagram illustrating how the presentation engine relies on script data files to provide the video player to the end user. In FIG. 7, the video player software 300 resides as a computer application on the end user's computer, on a server of a network, as an web applet, or the like. The video player software 300 parses scripts 310 to display the video and associated tangential content to the end user. The content 325 may be already loaded on the computer or may be available over the Internet or other network. The code blocks 320 are linked to the video player software 300 so that new functionality can be easily added.

While the specification describes particular embodiments of the present invention, those of ordinary skill can devise variations of the present invention without departing from the inventive concept. Although the scripts as explained herein are simplified for conceptual demonstration, one of ordinary skill in the art can easily use this disclosed information to create more complex scripts.

We claim:

1. A multimedia player for delivering to a user a multimedia presentation comprising video content, a plurality of slides, and tangential content, the multimedia player comprising:
a presentation control unit which provides a graphical user interface on a display device for allowing the user to manipulate the multimedia presentation; and
a presentation script parsed by the presentation control unit;
wherein the presentation script directs the interrelated display of the video content, the plurality of slides, and the tangential content of the multimedia presentation;
wherein the graphical user interface comprises a video display region for displaying the video content, and a slide region for displaying the plurality of slides;
wherein each of the plurality of slides is associated with a subset of the tangential content; and
wherein each of the plurality of slides accesses the associated subset of tangential content.

2. The multimedia player from claim 1, wherein the graphical user interface further comprises a tangential presentation region for displaying the tangential content.

3. The multimedia player from claim 1, wherein the graphical user interface further comprises a control panel for controlling the video display region.

4. The multimedia player from claim 1, wherein the user must affirmatively select one of the plurality of slides to access the associated subset of tangential content.

5. The multimedia player from claim 1, wherein at least one of the plurality of slides can automatically access the associated subset of tangential content without affirmative selection by the user.

6. The multimedia player from claim 1, wherein the multimedia presentation is directed to a procedure comprised of a plurality of steps;
wherein each of the plurality of steps in the procedure is associated with one of the plurality of slides.

7. The multimedia player from claim 1, wherein the presentation control unit and the presentation script are delivered to a computer over the Internet.

8. The multimedia player from claim 1, wherein the video content and the tangential content are delivered to a computer over the Internet.

9. A multimedia player for delivering to a user a presentation comprised of a video, a plurality of tangential content, and a presentation script, wherein each of the plurality of slides is associated to one of the plurality of tangential content, and wherein each of the plurality of slides is also associated to a specific playback time or frame within the video, and wherein the presentation script describes the relationships among the video, the plurality of tangential content and the plurality of slides, the multimedia player comprising:
a presentation control unit which provides the graphical user interface on a display device for displaying the video and the plurality of slides, and for allowing the user to manipulate the multimedia presentation; and
wherein the presentation control unit displays to the user the tangential content which has been associated to one of the slides according to the presentation script.

10. The multimedia player from claim 9, wherein the user must affirmatively select one of the plurality of slides for the presentation control unit to display the tangential content.

11. The multimedia player from claim 9, wherein the presentation control unit automatically accesses the associated subset of tangential content without affirmative selection by the user.

12. The multimedia player from claim 9, wherein the multimedia presentation is directed to a procedure comprised of a plurality of steps;
wherein each of the plurality of steps in the procedure is associated with one of the plurality of slides.

13. The multimedia player from claim 9, wherein the presentation control unit and the presentation script are delivered to a computer over the Internet.

14. The multimedia player from claim 9, wherein the video and the plurality of tangential content are delivered to a computer over the Internet.

15. A computerized method for delivering to a user a multimedia presentation comprised of a video and a plurality of tangential content, the method comprising:
controlling a graphical user interface on a display device for allowing the user to manipulate the multimedia presentation;
parsing a presentation script, wherein the presentation script comprises instructions describing the relationships between the plurality of tangential content to a plurality of slides, and the relationships between the plurality of slides and playback times or frames in the video; and
displaying to the user the multimedia presentation according to the presentation script.

16. The computerized method from claim 15, wherein the presentation script is delivered to a computer over the Internet.

17. A computer-readable medium having computer-executable instructions for performing a method for delivering to a user a multimedia presentation comprised of a plurality of multimedia content, the method comprising:
controlling a graphical user interface on a display device for allowing the user to manipulate the multimedia presentation;
parsing a presentation script, wherein the presentation script comprises instructions describing the relationships between the plurality of tangential content to a plurality of slides, and the relationships between the plurality of slides and playback times or frames in the video; and
displaying to the user the multimedia presentation according to the presentation script.

18. The computer-readable medium having computer-executable instructions for performing a method from claim 17, wherein the presentation script is delivered to a computer over the Internet.

19. A computerized authoring tool for creating a multimedia presentation comprising:
a video content file and a plurality of tangential content, the authoring tool comprising;
a presentation control unit which provides a graphical user interface on a display device for allowing a user to manipulate the multimedia presentation;
wherein the graphical user interface comprises a video display region for displaying the video content file; a control panel for controlling the graphical user interface, and a tangential content region for displaying the plurality of tangential content;
wherein the control panel allows a user to add a slide from a plurality of slides to the multimedia presentation, to associate the slide to a specific playback time or frame within the video content file and to associate one of the plurality of tangential content to the slide;
and wherein the presentation control unit creates a presentation script, wherein the presentation script comprises instructions describing the relationships between the plurality of tangential content to the plurality of slides, and the relationships between the plurality of slides and the playback times or frames in the video content file.

20. A computerized method for creating a multimedia presentation, the multimedia presentation comprising a video, a plurality of slides, and a plurality of tangential content, the method comprising:
providing a video player for manipulating the video;
choosing a time or frame within the video to have the multimedia presentation display a slide from the plurality of slides;
associating tangential content from the plurality of tangential content to the slide; and
generating a presentation script to be parsed by a second video player, wherein the presentation script describes the relationships among the time or frame within the video, the tangential content, and the slide.

21. A computer-readable medium having computer-executable instructions for performing a method for creating a multimedia presentation, the multimedia presentation comprising a video, a plurality of slides, and a plurality of tangential content, the method comprising:
providing a video player for manipulating the video;
choosing a time or frame within the video to have the multimedia presentation display a slide from the plurality of slides;
associating tangential content from the plurality of tangential content to the slide; and
generating a presentation script to be parsed by a second video player, wherein the presentation script describes the relationships among the time or frame within the video, the tangential content, and the slide.
